(19) United States
(12) Patent Application Publication
(10) Pub. No.: US 2017/0090222 A1
(43) Pub. Date: Mar. 30, 2017

(54) DEVICE AND METHOD FOR REMOVING IMPURITIES IN OPTICAL ALIGNMENT FILM

(71) Applicants: BOE Technology Group Co., Ltd., Beijing (CN); Hefei BOE Optolectronics Technology Co., Ltd., Anhui (CN)

(72) Inventor: Jun Zhang, Beijing (CN)

(21) Appl. No.: 15/140,560

(22) Filed: Apr. 28, 2016

(30) Foreign Application Priority Data
Sep. 25, 2015 (CN) 201510623836.1

(51) Int. Cl. G02F 1/13; B01D 46/00; B08B 7/00

(52) U.S. Cl. CPC G02F 1/1303; B08B 7/0071; B01D 46/00; G02F 2001/1316; G02F 1/1368

(57) ABSTRACT

The present disclosure provides a device and a method for removing impurities in an optical alignment film. The device includes: a heating apparatus configured to define a sealed cavity and configured for heating the alignment film placed in the sealed cavity; a gas extraction apparatus communicated with the sealed cavity through a gas extraction pipeline and configured for extracting gas in the sealed cavity; and a gas supply apparatus including a gas supply pipeline and a control switch, wherein the gas supply pipeline is communicated with the sealed cavity, and the control switch is configured for controlling to open or close the gas supply pipeline; the gas supply apparatus is configured for supplying the gas to the sealed cavity through the gas supply pipeline under the control of the control switch. The present disclosure is used to manufacture the display.

### CROSS-REFERENCE TO RELATED APPLICATION

This application claims the benefit of Chinese Patent Application No. 201510623836.1 filed on Sep. 25, 2015 in the State Intellectual Property Office of China, the whole disclosure of which is incorporated herein by reference.

### BACKGROUND OF THE INVENTION

Field of the Invention

Embodiments of the present disclosure relate to a technical field of display, in particular, to a device and a method for removing impurities in an optical alignment film.

Description of the Related Art

With the development of display technology, a display is more and more widely used in daily life. As a display, a thin film transistor liquid crystal display (TFT-LCD) has the following advantages: low driving voltage, high reliability, no radiation, no flicker, wide application range, and the like. As a result, the TFT-LCD becomes a main trend for the display.

In a TFT-LCD manufacturing process, there is a need for aligning liquid crystal, so as to control an initial arrangement of liquid crystal molecules in the TFT-LCD, thereby precisely controlling the arrangement of the liquid crystal molecules during displaying of the TFT-LCD to achieve a display effect. Therefore, aligning the liquid crystal is a very important process during the TFT-LCD manufacturing process. Existing alignment technologies include a contact type alignment technology and a non-contact type alignment technology. The most widely used contact type alignment technology is directed to a Rubbing Alignment, which may excellently align the liquid crystal molecules. However, static electricity and impurity particles, which may be generated in the alignment film during a contact process, are likely to directly damage liquid crystal elements. By means of the non-contact type alignment technology, it may be avoided from directly contacting with the alignment film, so that the generation of static electricity and impurity particles can be well avoided. At present, a well-known non-contact type alignment technology for the person skilled in the art is an ultraviolet light alignment method, an optical alignment for abbreviation. In particular, the optical alignment refers to irradiating a polyimide film (PI film) having photosensitizer with linearly polarized extreme ultraviolet light. Although such optical alignment avoids the generation of static electricity and impurity particles, portions of molecular chains of the PI film may be broken down after the PI film is irradiated by the linearly polarized extreme ultraviolet light, as a result, small molecule impurities are formed. If such small molecule impurities are kept in the TFT-LCD, some bright spots in a foreign matter form may appear during the displaying of the TFT-LCD, thereby adversely affecting the display effect of the TFT-LCD. In the prior art, such small molecule impurities are removed by heating and evaporating. However, if heating temperature is too low, a large number of impurities will not be evaporated which causes a poor impurity removal effect, on the other hand, if the heating temperature is too high, the alignment film and other elements may be adversely affected by the high temperature. Therefore, how to remove the small molecule impurities generated in the optical alignment film during the process of optical alignment without adversely affecting the alignment film and other elements is desired to be resolved by the person skilled in the art.

### SUMMARY OF THE INVENTION

The embodiments of the present disclosure provide a device and a method for removing impurities in an optical alignment film, which aims to remove small molecular impurities generated in the optical alignment film during an optical alignment process without adversely affecting the alignment film and other elements.

To arrive at the above objective, the embodiments of the present disclosure adopt the following technical solutions:

In a first aspect, there is provided a device for removing impurities in an optical alignment film, comprising:

a heating apparatus configured to define a sealed cavity and configured for heating the alignment film placed in the sealed cavity;

a gas extraction apparatus communicated with the sealed cavity through a gas extraction pipeline and configured for extracting gas in the sealed cavity; and

a gas supply apparatus comprising a gas supply pipeline and a control switch, wherein the gas supply pipeline is communicated with the sealed cavity, and the control switch is configured for controlling to open or close the gas supply pipeline; the gas supply apparatus is configured for supplying the gas to the sealed cavity through the gas supply pipeline under the control of the control switch.

Optionally, the gas extraction pipeline is arranged on a first side of the sealed cavity, and the gas supply pipeline of the gas supply apparatus is arranged on a second side of the sealed cavity; wherein the first side of the sealed cavity and the second side of the sealed cavity are located away from each other.

Optionally, the gas supply apparatus further comprises a filter mesh configured for filtering the gas entering into the sealed cavity.

Optionally, the heating apparatus is configured for heating the alignment film placed in the cavity to a preset temperature, which is greater than 190° C. and less than 250° C.

In a second aspect, there is provided a method for removing impurities in an optical alignment film, which is usable in the device for removing impurities in the optical alignment film according to any one of technical solutions in the first aspect, comprising:

controlling to start the gas extraction apparatus, and controlling to open the gas supply pipeline of the gas supply apparatus by the control switch of the gas supply apparatus, so as to exchange the gas in the sealed cavity defined by the heating apparatus;

controlling to start the heating apparatus when gas exchanging time reaches a preset time;

controlling to close the gas supply pipeline of the gas supply apparatus by the control switch of the gas supply apparatus when the temperature of the alignment film placed in the sealed cavity reaches a preset temperature.

Optionally, the method further comprises:

filtering the gas entering into the sealed cavity by a filter mesh before exchanging the gas in the sealed cavity defined by the heating apparatus.

Optionally, the preset temperature is greater than 190° C. and less than 250° C.

In a third aspect, there is provided a method for removing impurities in an optical alignment film, which is usable in the device for removing impurities in the optical alignment film according to any one of technical solutions in the first aspect, comprising:

controlling to start the gas extraction apparatus, and controlling to open the gas supply pipeline of the gas supply apparatus by the control switch of the gas supply apparatus, so as to exchange the gas in the sealed cavity defined by the heating apparatus;

controlling to close the gas supply pipeline of the gas supply apparatus by the control switch of the gas supply apparatus when gas exchanging time reaches a preset time;

controlling to start the heating apparatus, so as to heat the alignment film placed in the sealed cavity to a preset temperature when the pressure in the sealed cavity reaches a preset pressure.

Optionally, the method further comprises:

filtering the gas entering into the sealed cavity by a filter mesh before exchanging the gas in the sealed cavity defined by the heating apparatus.

Optionally, the preset temperature is greater than 190° C. and less than 250° C.

The device for removing impurities in the optical alignment film according to the embodiment of the present disclosure comprises: a heating apparatus configured to define a sealed cavity and configured for heating the alignment film placed in the sealed cavity; a gas extraction apparatus communicated with the sealed cavity through a gas extraction pipeline and configured for extracting gas in the sealed cavity; and a gas supply apparatus configured for supplying the gas to the sealed cavity through the gas supply pipeline under the control of the control switch. When the device for removing impurities in the optical alignment film is in operation, the pressure in the sealed cavity may be lowered by controlling to start the gas extraction apparatus and controlling to close the gas supply pipeline of the gas supply apparatus, thereby evaporating the small molecule impurities generated during the optical alignment process under a relatively low temperature. Therefore, the embodiments of the present disclosure enable to remove small molecular impurities generated in the optical alignment film during the optical alignment process without adversely affecting the alignment film and other elements.

### BRIEF DESCRIPTION OF THE DRAWINGS

In order to more clearly explain the embodiments of the present disclosure or the technical solutions in the prior art, drawings used in the description of the embodiments or the prior art will be briefly introduced below. Obviously, the drawings described below merely act as some embodiments of the present disclosure, other drawings may be obtained by the person skilled in the art based on these drawings, without creative effort.

FIG. 1 is a schematic structural view of a device for removing impurities in an optical alignment film according to an embodiment of the present disclosure;

FIG. 2 is a schematic view showing variation of impurity content as a function of temperature in an optical alignment film according to an embodiment of the present disclosure;

FIG. 3 is a schematic view showing variation of evaporating temperature as a function of vacuum degree according to an embodiment of the present disclosure;

FIG. 4 is a flow chart of a method for removing impurities in an optical alignment film according to an embodiment of the present disclosure; and

FIG. 5 is a flow chart of a method for removing impurities in an optical alignment film according to another embodiment of the present disclosure.

### DETAILED DESCRIPTION OF PREFERRED EMBODIMENTS OF THE INVENTION

The technical solution of the embodiments of the present disclosure will be further described in detail below, in combination with the accompanying figures in the embodiments of the present disclosure. Obviously, the described embodiments are merely a part of all embodiments, rather than all of embodiments. Based on the embodiments of the present disclosure, all of the other embodiments obtained by the person skilled in the art without creative effort fall into the scope of the present disclosure.

It will be appreciated that orientation or position relationships indicated by the term “center”, “longitudinal”, “lateral”, “upper”, “lower”, “front”, “rear”, “left”, “right”, “vertical”, “horizontal”, “top”, “bottom”, “inner”, “outer” and the like are based on the orientation or position relationships shown in the drawings, such limitation is only intended to facilitate the description of the present disclosure and simplify the description, rather than to indicate or imply that the related devices or elements must have that particular orientation, or must be constructed or operated in that particular orientation, therefore, it should not be construed as limiting the present disclosure.

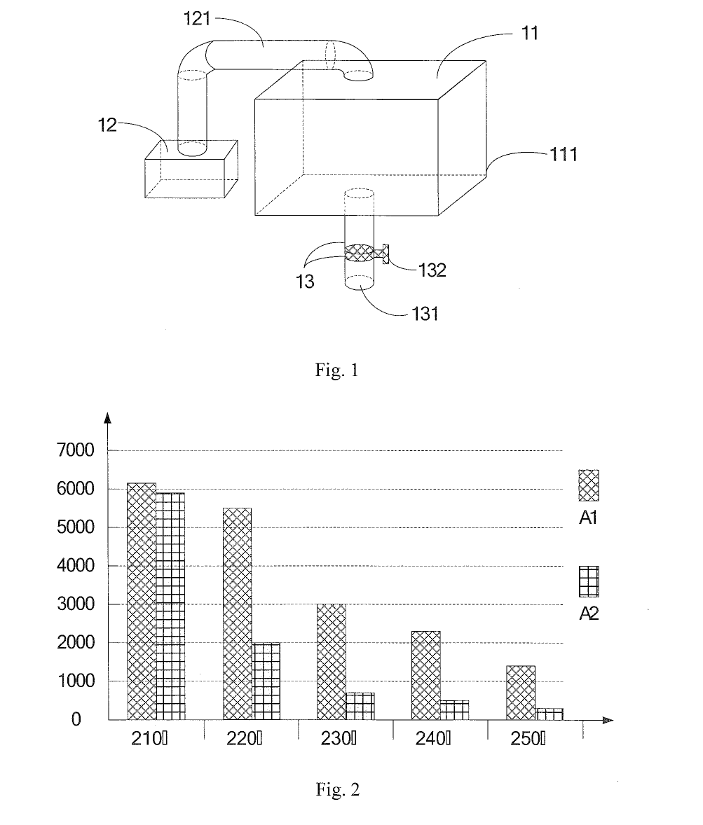

The embodiments of the present disclosure provide a device for removing impurities in an optical alignment film, in particular, as shown in FIG. 1, the device for removing impurities in the optical alignment film comprises a heating apparatus 11, a gas extraction apparatus 12 and a gas supply apparatus 13.

The heating apparatus 11 is configured to define a sealed cavity 111 and configured for heating the alignment film placed in the sealed cavity 111.

Exemplarily, the sealed cavity may have a shape of cuboid, cube or any other polyhedron, and it is not intended to limit the shape of the sealed cavity in the embodiments of the present disclosure.

The gas extraction apparatus 12 is communicated with the sealed cavity 111 through a gas extraction pipeline 121 and configured for extracting gas in the sealed cavity 111.

Exemplarily, the gas extraction apparatus may be a vacuum pump or any other apparatus having a similar function.

The gas supply apparatus 13 comprises a gas supply pipeline 131 and a control switch 132, wherein the gas supply pipeline 131 is communicated with the sealed cavity 111, and the control switch 132 is configured for controlling to open or close the gas supply pipeline 131; the gas supply apparatus 13 is configured for supplying the gas to the sealed cavity 111 through the gas supply pipeline 131 under the control of the control switch 132.

The device for removing impurities in the optical alignment film according to the embodiment of the present disclosure comprises: a heating apparatus configured to define a sealed cavity and configured for heating the alignment film placed in the sealed cavity; a gas extraction apparatus communicated with the sealed cavity through a gas extraction pipeline and configured for extracting gas in the sealed cavity; and a gas supply apparatus configured for supplying the gas to the sealed cavity through the gas supply pipeline under the control of the control switch. When the device for removing impurities in the optical alignment film is in operation, the pressure in the sealed cavity may be lowered by controlling to start the gas extraction apparatus and controlling to close the gas supply pipeline of the gas supply apparatus, thereby evaporating the small molecule impurities generated during the optical alignment process under a relatively low temperature. Therefore, the embodiments of the present disclosure enable to remove small molecular impurities generated in the optical alignment film during the optical alignment process without adversely affecting the alignment film and other elements.

Further, the gas extraction pipeline is arranged on a first side of the sealed cavity, and the gas supply pipeline of the gas supply apparatus is arranged on a second side of the sealed cavity; wherein the first side of the sealed cavity and the second side of the sealed cavity are located away from each other.

Before removing the small molecule impurities in the optical alignment film through heating, it is firstly necessary to exchange the gas in the sealed cavity. By means of arranging the gas extraction pipeline on the first side of the sealed cavity and arranging the gas supply pipeline of the gas supply apparatus on the second side of the sealed cavity which is located away from the first side of the sealed cavity, the gas extraction pipeline and the gas supply pipeline are arranged on the two sides of the sealed cavity away from each other, respectively, it enables the gas exchange in the sealed cavity to be more sufficient, thereby facilitating removing the small molecule impurities evaporated naturally in the sealed cavity. Exemplarily, the gas extraction pipeline and the gas supply pipeline may be arranged on opposite sides of the sealed cavity. For example, the gas extraction pipeline is arranged on a top surface of the sealed cavity while the gas supply pipeline is arranged on a bottom surface of the sealed cavity, or the gas extraction pipeline is arranged on a left surface of the sealed cavity while the gas supply pipeline is arranged on a right surface of the sealed cavity, or the gas extraction pipeline is arranged on a front surface of the sealed cavity while the gas supply pipeline is arranged on a rear surface of the sealed cavity.

Optionally, the gas supply apparatus 13 further comprises a filter mesh configured for filtering the gas entering into the sealed cavity.

Specifically, the filter mesh may be arranged in either side of the gas supply pipeline 131, or arranged in the gas supply pipeline 131. The embodiments of the present disclosure is not intended to limit arrangement position of the filter mesh, as long as it can filter the gas entering into the sealed cavity.

Dust particles, water vapour or other impurities may be contained in the atmosphere. Under such situation, if the dust particles along with air go into the sealed cavity, the optical alignment film placed in the sealed cavity may be contaminated. It may effectively prevent the impurities in the air from contaminating the optical alignment film by means of providing the filter mesh to filter the dust particles, water vapour and other impurities in the air. Optically, the material of the filter mesh may be an Ultra Low Penetration Air Filter (ULPA), or expended polytetrafluoroethylene (e-PTFE or expanded PTFE).

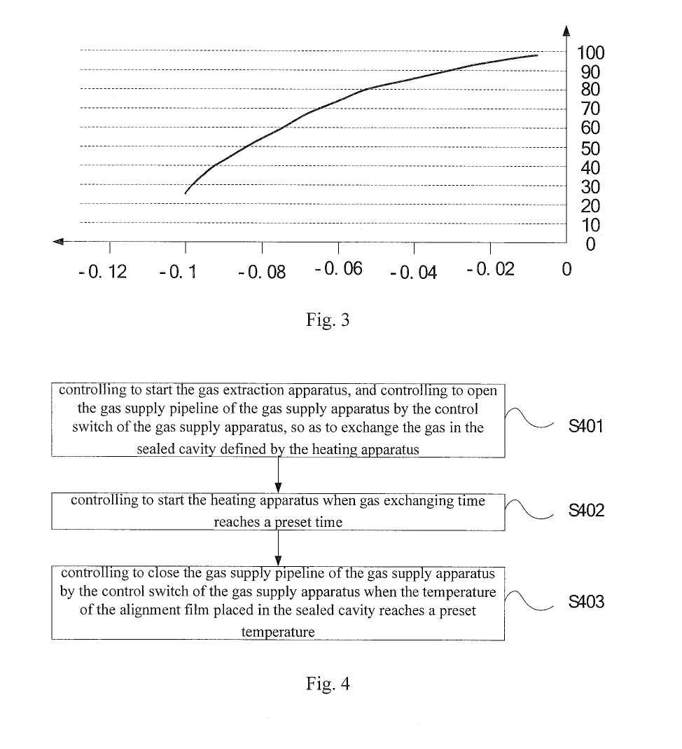

Further, as shown in FIGS. 2 and 3, FIG. 2 is a schematic view showing content of the small molecule impurities A1 and A2, which are generated from PI film experiencing an irradiation by linearly polarized extreme ultraviolet light, in the optical alignment film after being heated for 30 minutes under different temperatures, wherein the horizontal coordinate represents temperature value, and the vertical coordinate represents the content of the impurities in the optical alignment film (unit: PPM). It can be seen from FIG. 2 that the higher the temperature is, the less the impurities are remained in the optical alignment film. FIG. 3 is a schematic view showing affection of vacuum degree on evaporating temperature. In FIG. 3, the horizontal coordinate represents vacuum degree (unit: MPa), and the vertical coordinate represents temperature value (unit: ° C.), and the graph formed by connecting various points represents variation of the evaporating temperature as a function of the vacuum degree. It can be seen from FIG. 3 that the higher the vacuum degree is, the lower the evaporating temperature is.

It can be seen from the above schematic FIGS. 2 and 3 that, the impurities in the optical alignment film may be removed through increasing the temperature and the vacuum degree, and it is desirable to allow the temperature to be as high as possible without damaging the optical alignment film, and the vacuum degree to be as high as possible. Optionally, the heating apparatus is configured for heating the alignment film placed in the cavity to a preset temperature, which is greater than 190° C. and less than 250° C.

It should be noted that, when reducing gas pressure in the sealed cavity, it is ideal to reduce the pressure in the sealed cavity to zero, that is, absolute vacuum state, however, it is not possible to achieve absolute vacuum state in the sealed cavity due to process limitations. Therefore, the embodiments of the present disclosure are not intended to limit the vacuum degree of the sealed cavity, but rather, the higher the vacuum degree of the sealed cavity, the better. In addition, the small molecule impurities in the alignment film will be more and more evaporated as the temperature is rising, on the other hand, excessively high temperature may damage the optical alignment film. Therefore, it is preferable to set the heated temperature of the alignment film to be greater than 190° C. and less than 250° C.

The embodiments of the present disclosure provide a method for removing impurities in an optical alignment film, which is usable in the device for removing impurities in the optical alignment film according to any one of the above embodiments. In particular, as shown in FIG. 4, the method comprises steps of:

S401: controlling to start the gas extraction apparatus, and controlling to open the gas supply pipeline of the gas supply apparatus by the control switch of the gas supply apparatus, so as to exchange the gas in the sealed cavity defined by the heating apparatus.

The gas exchange in the sealed cavity may remove the small molecule impurities and other impurity gas evaporated naturally in the sealed cavity.

S402: controlling to start the heating apparatus when gas exchanging time reaches a preset time.

The preset time may be determined according to volume of the sealed cavity, gas exchanging velocity, and any other actual data, and it is not intended to limit the gas exchanging time in the present disclosure.

S403: controlling to close the gas supply pipeline of the gas supply apparatus by the control switch of the gas supply apparatus when the temperature of the alignment film placed in the sealed cavity reaches a preset temperature.

In the step S403, the gas supply pipeline of the gas supply apparatus is closed by controlling the control switch of the gas supply apparatus, then the gas extraction apparatus, which is still working, may enable the gas pressure in the sealed cavity to be decreased gradually, thereby the vacuum degree is increasing gradually. As a result, the small molecule impurities in the optical alignment film may be removed more sufficiently.

In the method for removing impurities in the optical alignment film according to the embodiment of the present disclosure, the gas extraction apparatus is firstly controlled to start to work, and the gas supply pipeline of the gas supply apparatus is controlled to be opened by the control switch of the gas supply apparatus, so as to exchange the gas in the sealed cavity defined by the heating apparatus; the heating apparatus is then controlled to start to work, so as to heat the optical alignment film; at last, the gas supply pipeline of the gas supply apparatus is controlled to be closed by the control switch of the gas supply apparatus when the temperature of the alignment film reaches a preset temperature, and the gas extraction apparatus continues to work under such situation, thus it enables the gas pressure in the sealed cavity to be decreased gradually and the vacuum degree to be increased gradually. It can be seen that the embodiments of the present disclosure may remove the small molecule impurities generated in the optical alignment process under a relatively low temperature. Therefore, the embodiments of the present disclosure enable to remove the small molecular impurities generated in the optical alignment film during the optical alignment process without adversely affecting the alignment film and other elements.

Optionally, the method further comprises:

filtering the gas entering into the sealed cavity by a filter mesh before exchanging the gas in the sealed cavity defined by the heating apparatus.

Dust particles, water vapour or other impurities may be contained in the atmosphere. Under such situation, if the dust particles along with air go into the sealed cavity, the optical alignment film placed in the sealed cavity may be contaminated. By means of filtering the gas entering into the sealed cavity by a filter mesh before exchanging the gas in the sealed cavity defined by the heating apparatus, the dust particles, water vapour and other impurities in the air are filtered, thereby effectively preventing the impurities in the air from contaminating the optical alignment film.

Optionally, the preset temperature is greater than 190° C. and less than 250° C.

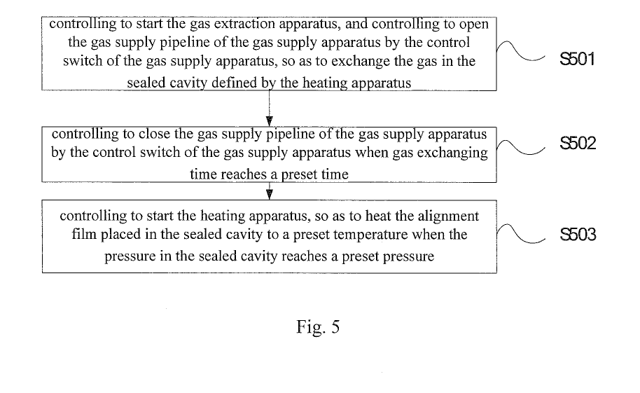

The embodiments of the present disclosure provide a method for removing impurities in an optical alignment film, which is usable in the device for removing impurities in the optical alignment film according to any one of the above embodiments. In particular, as shown in FIG. 5, the method comprises steps of:

S501: controlling to start the gas extraction apparatus, and controlling to open the gas supply pipeline of the gas supply apparatus by the control switch of the gas supply apparatus, so as to exchange the gas in the sealed cavity defined by the heating apparatus.

The gas exchange of the sealed cavity may remove the small molecule impurities and other impurity gas evaporated naturally in the sealed cavity.

S502: controlling to close the gas supply pipeline of the gas supply apparatus by the control switch of the gas supply apparatus when gas exchanging time reaches a preset time.

The preset time may be determined according to volume of the sealed cavity, gas exchanging velocity, and any other actual data, and it is not intended to limit the gas exchanging time in the present disclosure. In the step S502, when the preset time is reached, the gas supply pipeline of the gas supply apparatus is closed by controlling the control switch of the gas supply apparatus, then the gas extraction apparatus, which is still working, may enable the gas pressure of the sealed cavity to be decreased gradually, thereby the vacuum degree is increasing gradually. As a result, the small molecule impurities in the optical alignment film may be further evaporated as the vacuum degree is increasing.

S503: controlling to start the heating apparatus, so as to heat the alignment film placed in the sealed cavity to a preset temperature when the pressure in the sealed cavity reaches a preset pressure.

It should be noted that, in an ideal condition, the sealed cavity presents an absolute vacuum state, i.e., the preset pressure is zero, however, it may be not possible for the vacuum degree obtained by the actual gas extraction apparatus to reach absolute vacuum state, so the preset pressure herein may be set to a minimum pressure, which can be obtained in the sealed cavity.

When the pressure reaches the preset pressure, the step of heating the optical alignment film to a preset temperature may further evaporate the small molecule impurities in the optical alignment film.

In the method for removing impurities in the optical alignment film according to the embodiment of the present disclosure, the gas extraction apparatus is firstly controlled to start to work, and the gas supply pipeline of the gas supply apparatus is controlled to be opened by the control switch of the gas supply apparatus, so as to exchange the gas in the sealed cavity defined by the heating apparatus; the gas supply pipeline of the gas supply apparatus is then controlled to be closed by the control switch of the gas supply apparatus, the pressure in the sealed cavity is decreased and the vacuum degree is increased, by means of the continuing work of the gas extraction apparatus; at last, the heating apparatus is controlled to start to work, so as to heat the alignment film placed in the sealed cavity to a preset temperature when the pressure in the sealed cavity reaches a preset pressure. It can be seen that the embodiments of the present disclosure may remove the small molecule impurities generated during the optical alignment process under a relatively low temperature. Therefore, the embodiments of the present disclosure enable to remove the small molecular impurities generated in the optical alignment film during the optical alignment process, without adversely affecting the alignment film and other elements.

Optionally, the method further comprises:

filtering the gas entering into the sealed cavity by a filter mesh before exchanging the gas in the sealed cavity defined by the heating apparatus.

Dust particles, water vapour or other impurities may be contained in the atmosphere. Under such situation, if the dust particles along with air go into the sealed cavity, the optical alignment film placed in the sealed cavity may be contaminated. By means of filtering the gas entering into the sealed cavity by a filter mesh before exchanging the gas in the sealed cavity defined by the heating apparatus, the dust particles, water vapour and other impurities in the air are filtered, thereby effectively preventing the impurities in the air from contaminating the optical alignment film.

Optionally, the preset temperature is greater than 190° C. and less than 250° C.

The above description is merely some detailed implements of the present disclosure, but the scope of the present disclosure is not limited thereto. Any modifications and alterations to the present disclosure, which is easily envisaged by the person skilled in the art, fall into the scope of the present disclosure. Therefore, the scope of the present disclosure is defined in the accompanying claims.

What is claimed is:

1. A device for removing impurities in an optical alignment film, comprising:
a heating apparatus configured to define a sealed cavity and configured for heating the alignment film placed in the sealed cavity;
a gas extraction apparatus communicated with the sealed cavity through a gas extraction pipeline and configured for extracting gas in the sealed cavity; and
a gas supply apparatus comprising a gas supply pipeline and a control switch, wherein the gas supply pipeline is communicated with the sealed cavity, and the control switch is configured for controlling to open or close the gas supply pipeline; the gas supply apparatus is configured for supplying the gas to the sealed cavity through the gas supply pipeline under the control of the control switch.

2. The device according to claim 1, wherein the gas extraction pipeline is arranged on a first side of the sealed cavity, and the gas supply pipeline of the gas supply apparatus is arranged on a second side of the sealed cavity; wherein the first side of the sealed cavity and the second side of the sealed cavity are located away from each other.

3. The device according to claim 1, wherein the gas supply apparatus further comprises a filter mesh configured for filtering the gas entering into the sealed cavity.

4. The device according to claim 1, wherein the heating apparatus is configured for heating the alignment film placed in the cavity to a preset temperature, which is greater than 190° C. and less than 250° C.

5. The device according to claim 2, wherein the heating apparatus is configured for heating the alignment film placed in the cavity to a preset temperature, which is greater than 190° C. and less than 250° C.

6. The device according to claim 3, wherein the heating apparatus is configured for heating the alignment film placed in the cavity to a preset temperature, which is greater than 190° C. and less than 250° C.

7. A method for removing impurities in an optical alignment film, which is usable in the device for removing impurities in the optical alignment film according to claim 1, comprising:
controlling to start the gas extraction apparatus, and controlling to open the gas supply pipeline of the gas supply apparatus by the control switch of the gas supply apparatus, so as to exchange the gas in the sealed cavity defined by the heating apparatus;
controlling to start the heating apparatus when gas exchanging time reaches a preset time;
controlling to close the gas supply pipeline of the gas supply apparatus by the control switch of the gas supply apparatus when the temperature of the alignment film placed in the sealed cavity reaches a preset temperature.

8. The method according to claim 7, wherein the gas extraction pipeline is arranged on a first side of the sealed cavity, and the gas supply pipeline of the gas supply apparatus is arranged on a second side of the sealed cavity; wherein the first side of the sealed cavity and the second side of the sealed cavity are located away from each other.

9. The method according to claim 7, further comprising:
filtering the gas entering into the sealed cavity by a filter mesh before exchanging the gas in the sealed cavity defined by the heating apparatus.

10. The method according to claim 7, wherein the preset temperature is greater than 190° C. and less than 250° C.

11. A method for removing impurities in an optical alignment film, which is usable in the device for removing impurities in the optical alignment film according to claim 1, comprising:
controlling to start the gas extraction apparatus, and controlling to open the gas supply pipeline of the gas supply apparatus by the control switch of the gas supply apparatus, so as to exchange the gas in the sealed cavity defined by the heating apparatus;
controlling to close the gas supply pipeline of the gas supply apparatus by the control switch of the gas supply apparatus when gas exchanging time reaches a preset time;
controlling to start the heating apparatus so as to heat the alignment film placed in the sealed cavity to a preset temperature when the pressure in the sealed cavity reaches a preset pressure.

12. The method according to claim 11, wherein the gas extraction pipeline is arranged on a first side of the sealed cavity, and the gas supply pipeline of the gas supply apparatus is arranged on a second side of the sealed cavity; wherein the first side of the sealed cavity and the second side of the sealed cavity are located away from each other.

13. The method according to claim 11, further comprising:
filtering the gas entering into the sealed cavity by a filter mesh before exchanging the gas in the sealed cavity defined by the heating apparatus.

14. The method according to claim 11, wherein the preset temperature is greater than 190° C. and less than 250° C.
